(19) United States
(12) Patent Application Publication
(10) Pub. No.: US 2007/0138660 A1
(43) Pub. Date: Jun. 21, 2007

(54) Method and system for generating olfactory and tactual effects in motion pictures

(76) Inventor: Yixin Guo, Ronkonkoma, NY (US)

Correspondence Address: Yixin Guo, 256 Holbrook Avenue, Ronkonkoma, NY, 11779, US

(21) Appl. No.: 11/357,845

(22) Filed: Feb. 21, 2006

Related U.S. Application Data
(60) Provisional application No. 60/751,587, filed on Dec. 20, 2005.

(51) Int. Cl. B01F 3/04

(52) U.S. Cl. 261/26; 261/DIG. 88

(57) ABSTRACT

A method and system for generating olfactory and tactual effects in combination with the visual and auditory effects in motion pictures. When a film is being projected, olfactory signals are detected by the multi-channel device in the film projector and are transmitted to an odor-control electromagnetic valve, which sends the pressurized odor to the multi-functional emission box via pressure relief valve until the odor is released into the inside of cinema in synch with the development of the film plots. During film projection, tactual signals are detected by the multi-channel device of the film projector and are transmitted to a water-control electromagnetic valve, which sends water to a sprinkler head or a fog-spraying head to simulate the effects of raining, sneezing, and other effects in synch with the development of film plots. Tactual signals can also be used to actuate vibrators installed in audience seats to produce the effects of shaking and bumping. In summary, this invention provides such dynamic effects as odor-smelling, wind-blowing, raining, and so on that correspond to the same phenomena appearing in the screens of existing motion pictures, which also offers visual and auditory effects simultaneously. As a result, audiences will experience the quadrate effect of viewing, hearing, smelling, and touching during film-watching; thus the entertaining and amusement effects of motion pictures are greatly enhanced.

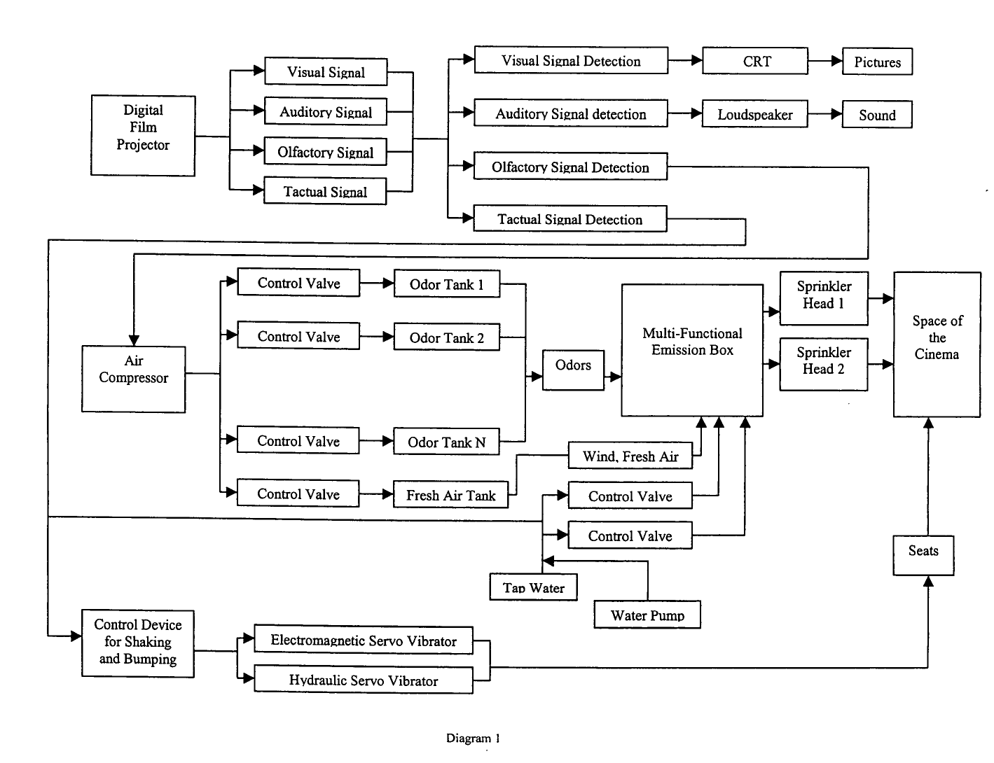

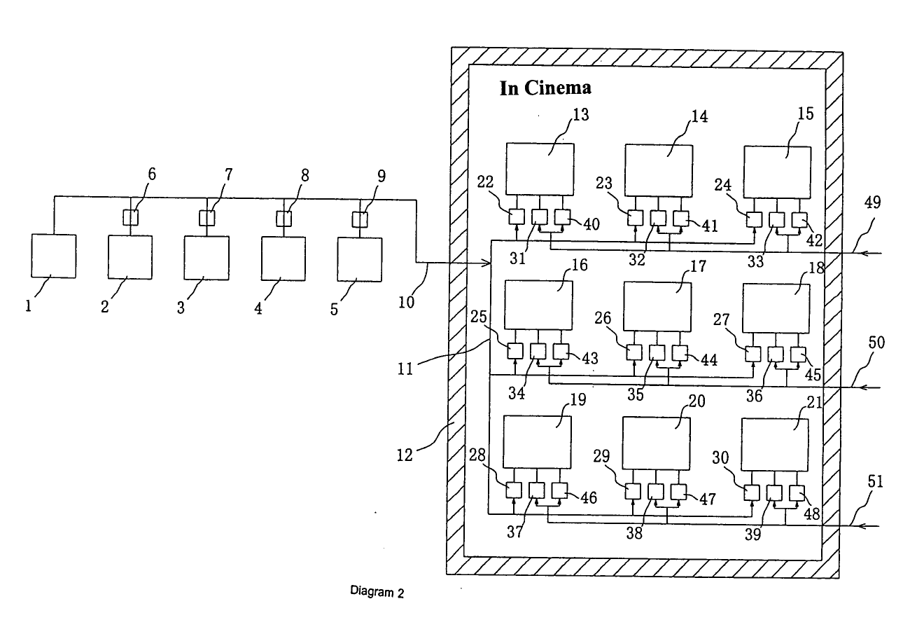

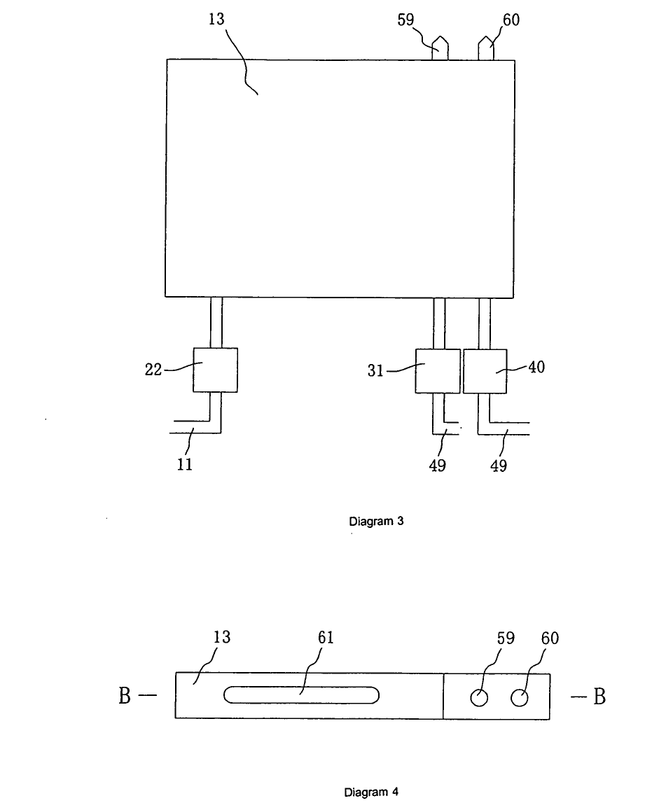

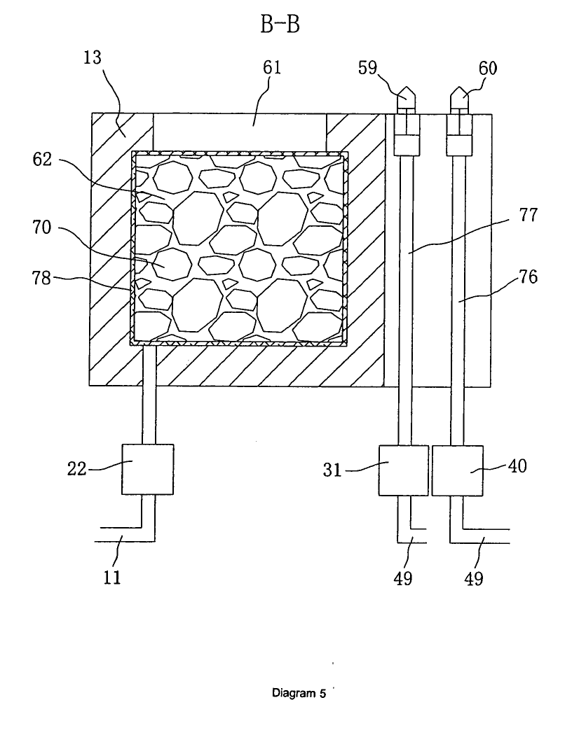

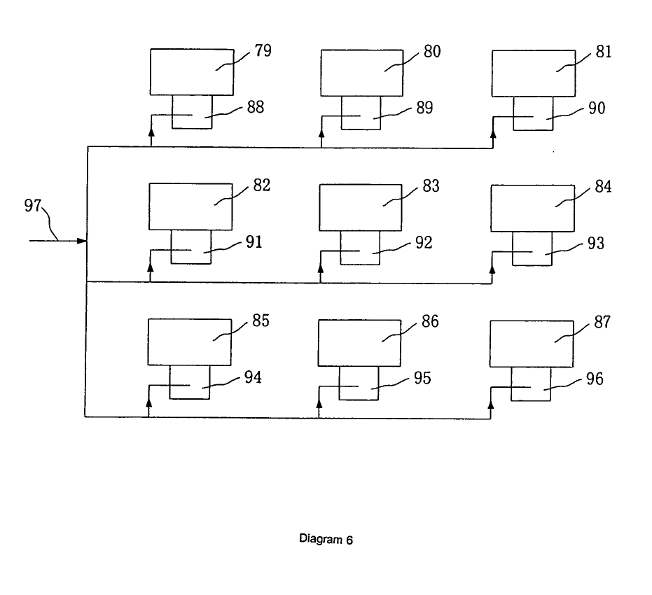

### FIELD OF THE INVENTION

This invention pertains to the field of motion pictures; especially it is concerned with techniques and equipments that produce olfactory and tactual effects in existing motion pictures that are based on traditional visual and auditory effects. Boasting of a breakthrough in modern cinematographic art that is dominated by traditional visual-auditory effects, this invention designs to display a quadrate effect that makes use of the four human senses during film-watching: viewing, hearing, smelling, and touching.

### BACKGROUND OF THE INVENTION

Nowadays, watching films has become an indispensable part in people's life. In addition to bringing enjoyment and amusement to people's life, motion pictures are providing large quantities of knowledge and information to moviegoers. It is obvious that modern movie industry attaches great importance to the enhancement of visual-auditory effects in motion pictures. On the other hand, it is also apparent that humans obtain knowledge and information not only through the senses of viewing and hearing but also through the senses of touching, smelling, and tasting. Keeping people enjoying their favorite films only by using the two senses of viewing and hearing will greatly restrict people's enjoyment of such films, which are also regarded as one form of culture and art.

It is widely-known that modern movies are capable of providing large numbers of visual and auditory effects to audiences. Unfortunately there has never been a film in existence that can also produce olfactory and tactual effects. The main difficulties for doing that are: (1) odors are chemical substances whose components are so complex that they cannot be created simply by combining a few chemical elements together; and at present, there are very few electronic sensors that can convert odors to electronic signals. As a result, no equipment has ever been invented that can receive or transmit olfactory signals during the process of producing or projecting a film. (2) Tactual effects are even more difficult and complicated to produce or simulate in motion pictures.

With the development of modern cinematographic art, people have already realized the importance of producing olfactory and tactual effects in motion pictures. On the other hand, however, no practical designs have ever been invented that are capable of producing olfactory and tactual effects in motion pictures so that the quadrate effect of viewing, hearing, smelling and touching can be experienced during film-watching.

### SUMMARY OF THE INVENTION

This invention will provide details on techniques and corresponding equipments that can produce olfactory and tactual effects in motion pictures. The purpose of the said invention is to enable existing motion pictures to generate olfactory and tactual effects in synch with the physical phenomena in film screen, such as emitting different odors, wind-blowing, raining, sneezing, shaking, bumping, and so on. As a result, the simultaneous activation of the four human senses of viewing, hearing, smelling, and touching will definitely place audiences on the scene of the film, thus further enhancing the entertaining effect of the film.

In order to accomplish the above purposes, this invention designs a technical scenario that is capable of producing olfactory and tactual effects in motion pictures. The details are described as follows:

1. In accordance with the plots of the film, olfactory and tactual signals that work in concert with visual and auditory signals will be designed; and the default signal system for the olfactory and tactual signals will be one of these: digital, analog, optical, or magnetic. Olfactory signals will be released according to the types of the targeted odors, and tactual signals will include at least one of the following signals:
1) Signal that simulates wind-blowing;
2) Signal that simulates raining;
3) Signal that simulates sneezing;
4) Signal that simulates shaking;
5) Signal that simulates bumping.

2. One of the following two techniques will be chosen for the production of olfactory and tactual signals:
1) Olfactory and tactual signals are integrated with the visual and auditory signals of the film;
2) Olfactory and tactual signals are generated using simulation programming independent of but in synchronization with the visual and auditory signals of the film.

3. During the process of film projection, olfactory and tactual signals are released in synchronization with the development of the plots of the film. Specifically, after being detected by a detection circuit, olfactory signals activate a set of control units by means of a control circuit. The set of control units then forces odors into their corresponding pipes while activating the odor exits located around audiences where odors that correspond to the pictures and sounds in the film are sent off.

Similarly, upon being detected by the detection circuit, tactual signals activate a set of control units and trigger the corresponding tactual simulation devices located around audiences, producing simulated tactual effects that synchronize with the corresponding pictures and sounds in the film. The devices that produce simulated tactual effects will include at least one of the following:
1) Device that simulates wind-blowing;
2) Device that simulates raining;
3) Device that simulates sneezing;
4) Device that simulate shaking and/or bumping.

### DETAIL DESCRIPTION

Specific details of the technical scenario for the production of the two signals are described as follows:

1. In the above technical scenario, at least two different types of odors in the following categories will be included:

Flower fragrance, perfume scent, coffee smell, cooking odor, fruit smell, the smell of sourness, spiciness, funkiness, the smell of raw meat or fish, smoking smell, the smell of gun powder and fresh air.

2. In the above technical scenario, odors can be stored either in a liquefied state or in an air-compressed state. When the odor is stored in a liquefied state, it can be evaporated by heating and released through an air pipe before being emitted into the air by way of the odor exits (No air compressor is necessary for the emitting of the odor, which actually can be released by controlling the electromagnetic valve in an odor tank); or odors can be released using pressurized spraying technique and then are emitted into the air through odor exits (In this case, air compressor is necessary for the releasing of odors in the form of fogs).

When odors are stored in an air-compressed state, they can be released into the air pipe through a valve before being emitted into the air by way of the odor exits (In this case, no air compressor is necessary for the emitting of odors, which actually can be released by controlling the electromagnetic valve in the odor tank); or the pressurized odors can be stored in a pressure tank, and, controlled by the odor-emitting signal, be emitted into the air pipe until they are finally released into the air through air/odor exits.

3. In the above scenario, the strength to which the targeted odor is smelled by audiences can be regulated by controlling the length of time used to keep the odor exits open as well as by controlling the size of the odor exits' apertures. The strengths of wind-blowing and raining can also be regulated by controlling the length of time used to keep the wind-blowing exits and the sprinkler heads open as well as by controlling the size of the apertures of the wind-blowing exits and of the sprinkler heads.

4. In the above scenario, tactual effects can be generated by triggering tactual simulation devices installed around audiences. Specifically:
1) Wind-blowing can be produced by means of electrical fans or air-blowing devices which blow wind upon audiences;
2) Raining can be produced by sprinkling water over audiences, which then free falls upon audiences;
3) Sneezing can be produced by promptly spraying fogs upon audiences, especially upon their faces;
4) Shaking and bumping can be produced by installing servo electromagnetic vibrators or servo hydraulic vibrators which move the cinema seats back and forth, and up and down.

5. In the above scenario, there are two means to produce olfactory and tactual effects. One means is to combine the olfactory and tactual effects in the film with its visual and auditory effects. In this case, during film projection, motion-picture projector or DVD player produces olfactory and tactual signals in synch with the development of the film plots (These signals can be programmed during the process of making digital films). For best effects, the olfactory and tactual signals can be processed and transmitted by the use of multi-channel digital projectors.

The other means to produce olfactory and tactual effects in a film is to generate olfactory and tactual signals using simulation program. In this case, these signals are independent of the film's visual and auditory signals. The simulation program used for producing olfactory and tactual signals is not linked to the film projector. When the film is being projected, a special device is used for producing olfactory and tactual signals in synch with the development of the film plots. This type of isolated simulation program can be combined with any types of film projectors, and can be used for producing olfactory and tactual effects in any films;

6. In the above scenario, after odors are produced inside the cinema, fresh air can be sent into the air pipe to clear the odors. In addition, central air conditioning system installed in the cinema can also be used to refresh the air around the audiences. Installing separate devices to ventilate the cinema is also a good choice;

7. In the above scenario, fresh air contained in an odor tank can be used to produce natural wind, and it can also be used to refresh the air in the cinema.

In order to achieve the above-mentioned purposes, this invention designs a technical scenario that is capable of generating olfactory and tactual effects. This scenario consists of olfactory- and tactual-simulation devices, which include the following:
1) A set of odor tanks and corresponding air pipes; and each odor tank contains different odors;
2) Water pipes, pumps, or tap water;
3) Multi-functional emission boxes, which are installed around the seats in the cinema. Each box contains an odor-emitting device, a wind-blowing simulation device, and a raining simulation device.
Specifically, the odor-emitting device consists of a set of control system components, a buffer chamber, and an odor exit. The buffer chamber links to the air pipe through the control system components while open to the audience via odor exit. The air pipe connects to one set of odor tanks through another set of control system components, forming the odor-emitting device.
The wind-blowing simulation device consists of a fan or a wind-blowing exit and of a set of control system components. The wind-blowing exit and the set of control system components connect to an air compressor or the fan via air pipes.
The raining simulation device consists of sprinkler heads and a set of control system components. The sprinkler heads and the set of control system components connect to the water pump and tap water via water pipes;
4) Control device and drive circuit. The control device is a control circuit or a control module with a CPU processor. The input terminal of the control circuit or the control module receives the olfactory and tactual signals generated in synch with the development of the film plots. The output terminal connects to the control terminal of the drive circuit of each control system component. Each drive circuit connects to its corresponding control system components.

The details of above technical scenario are provided as follows:

1. Locations where the multi-functional emission boxes are installed:
1) The hind back of each seat in the cinema with the audience sitting behind as the emission target;
2) The underside of each seat with the audience sitting above as the emission target;
3) The front of each seatback with the audience sitting in the same seat as the emission target.
When the same multi-functional emission boxes are installed on the seats in the same arrangement, the regulation of the functions of the same control system components can be controlled either on the one-to-one basis or one-to-more basis.
4) The buffer chamber in the technical scenario is a chamber whose sidewall is decorated with deadening felt and whose inside is filled with sound-absorbing materials.
5) The multi-functional emission box also contains a sneezing-simulation device, which consists of a fog-spraying head, and its corresponding control system components. The fog-spraying head and the control system components connect to the water pump or the tap water through water pipe.
6) The olfactory and tactual simulation devices in the technical scenario include a servo electromagnetic vibrator, a servo hydraulic vibrator, and corresponding control system components. The servo electromagnetic vibrator and the servo hydraulic vibrator are installed on the underside of the seat to produce the effects of shaking and bumping.
7) The control system components consist of the control valve, electric relay or electric switch. The control valve is made up of an electromagnetic valve, the hydraulic control system components, pneumatic control system components, or the servo control system components.
8) In order to make sure that all the multi-functional emission boxes in the cinema emit odors simultaneously, air compressors can be activated by the olfactory signals so that odors in the odor tank can first be transmitted to entrances located in different positions inside the cinema via air pipes. Then the amount of odors that pass through the entrances is regulated by the control system components as the odors enter the buffer chamber of the multi-functional emission boxes where they are emitted into the air of the cinema. In this way, odors coming from different positions in the cinema can be emitted into the air simultaneously regardless of the number of the multi-functional emission boxes used,

The process of producing olfactory and tactual effects in this invention is detailed as follows:

1. Process of Emitting Odors
When digital films or digital players based on specific programs detect the olfactory signal released in accordance with the plot development of the film, the olfactory signal will be sent to the control device. The control device then processes and releases the olfactory signal to trigger the air compressor as well as the control system components (such as the electromagnetic valve) in the odor tank, which force the odor or liquid out of the tank. Odors then flow to the multi-functional emission boxes by way of air pipes. In the emission boxes they are processed in the bumper chamber for noise reduction (noise will be reduced to the minimum) before being released into the air surrounding audiences.

2. Process of Simulating Wind-Blowing Effect
When digital films or digital players based on specific programs detect the tactual signal simulating the effect of wind-blowing released in accordance with the plot development of the film, the tactual signal will be sent to the control device. The control device then processes and releases the tactual signal to trigger (1) the fan which blows wind upon the audiences, or (2) the control system components (such as the electromagnetic valve) in the wind exit and the air compressor or the fan, or (3) the air compressor, odor tank that contains fresh air and the control system components (such as the electromagnetic valve) in the odor exit, causing a simulation of natural wind.

3. Process of Simulating Raining Effect
First, water is sent to the multi-functional emission box installed in the cinema by means of water pipe. When digital films or digital players based on specific programs detect the tactual signal simulating the raining effect released in accordance with the plot development of the film, the tactual signal will be sent to the control device. The control device then processes and releases the tactual signal to trigger the control system components (such as the electromagnetic valve). Then water is sprayed upon above the audiences via sprinkler heads and free falls down, simulating raining. When the tactual signal turns off the electromagnetic valve, water stops from spraying. Sprinkler heads differ from each other in terms of the diameters of the water holes in the head for the benefit of simulating different amounts of rain. The sprinkler heads are replaceable.

4. Process of Simulating Sneezing Effect
The process of simulating sneezing effect is similar to that of simulating raining effect. The major difference between the two processes is that sneezing effect is produced by quickly and briefly spraying fogs upon the faces or other surfaces of the audience.

5. Process of Simulating Shaking and Bumping Effects
When digital films or digital players based on specific programs detect tactual signals simulating the effects of shaking and bumping released in accordance with the plot development of the film, the tactual signals will be sent to the control device. The control device then processes and releases the tactual signals via the control system components (such as switches or relay devices) to trigger the servo electromagnetic vibrator or servo hydraulic vibrator, which moves seats back and forth, and up and down for the effects of shaking and bumping.
The shaking and bumping effects can be used to simulate the vibration of cars and ships, the zero gravity of airplanes or spaceships, free fall of humans from high cliffs, the effect of earthquakes, and other vibrating activities. The tactual signals simulating the effects of shaking and bumping can be recorded during on-spot shooting of films. They can also be programmed by writing related computer program.

Due to the employment of the above technical scenario, this invention is characteristic of the following advantages:
1. This invention combines olfactory and tactual effects with the traditional visual-auditory effects in films, thus greatly enhancing the entertaining effect of films. If this invention is applied to 3D films, the multi-dimensional effects of viewing, hearing, smelling, and touching will make film-watching more amusing and enjoyable;
2. This invention that combines olfactory and tactual effects with the traditional visual-auditory effects in films will open a new field for the research, production, and marketing of digital film projectors;
3. This invention that combines olfactory and tactual effects with the traditional visual-auditory effects in films will open a new field for film production, the advancement of cinematographic art, the research, production, and marketing of 3D films;
4. this invention that combines olfactory and tactual effects with the traditional visual-auditory effects in films, such as simulating the effects of odor-smelling, wind-blowing, water sprinkling, emitting of flower fragrance, sneezing, raining, etc., will open a new field for the research, production, and marketing of multi-functional 3D films and multi-dimensional films in play fields and amusement parks.

### BRIEF DESCRIPTION OF THE DRAWINGS

Diagram 1 is the schematic diagram of this invention;

Diagram 2 is the layout schematic drawing of this invention that illustrates where devices that produce olfactory and tactual effects in films are installed in the cinema;

Diagram 3 is the front view of the multi-functional emission box of this invention;

Diagram 4 is the vertical view of Diagram 3;

Diagram 5 is the B-B sectional drawing of Diagram 4;

Diagram 6 is the layout schematic drawing of this invention and shows the production of the effects of shaking and bumping.

In the above diagrams,
1 air compressor; 59 sprinkler head;
2-4 odor tanks; 60 fog-spray head;
5 fresh air tank; 61 odor exit;
6-9 electromagnetic valve; 62 buffer chamber;
10-11 air pipe; 70 sound-absorbing material;
12 partition boards in the cinema; 76-77 water pipe;
13-21 multi-functional emission box; 78 deadening material;
22-30 Pressure relief valve; 79-87 audience's seats;
31-39 electromagnetic valve; 88-96 servo hydraulic vibrator;
40-48 electromagnetic valve; 97 signals for simulating the effects of
49-51 water pipe; shaking and bumping.

### EXAMPLES OF THE INVENTION

The detailing of this invention based on diagrams will be provided by using the following examples:

### Example 1

This example illustrates one technique of producing olfactory and tactual effects. as Diagram 1. The details are as follows:

1. Based on the plots of the film, olfactory and tactual signals that work in concert with visual and auditory signals will be designed, and the default signal system for producing the olfactory and tactual signals will be digital signal system. Specifically, the release of olfactory signals is based on the types of the targeted odors, and tactual signals will include at least one of the following signals: 1) signals that simulate wind-blowing, 2) signals that simulate raining, 3) signals that simulate sneezing, 4) signals that simulate shaking, and 5) signals that simulate bumping.

2. Olfactory and tactual signals are produced in combination with the visual and auditory signals of the film. During film projection, the projector or DVD player produces olfactory and tactual signals in synch with the development of the film plots. These signals can be programmed during the process of making digital films, and the olfactory and tactual signals can be detected and transmitted by means of multi-channel devices in digital film projectors.

3. During film projection, olfactory and tactual signals are released in synchronization with the development of the plots of the film. Specifically, as soon as they are detected by the detection circuit, the olfactory signals activate a set of control system components via the control circuit, which releases odor into air pipes and activates odor exits. Then odors that correspond to the pictures of sounds in the film are released into the air via odor exits located around the audiences.

After being detected by the detection circuits, the tactual signals activate a set of control system components by means of the control circuit, which triggers the corresponding tactual-effect-simulation devices located around the audiences, thus producing simulated tactual effects that correspond to the pictures and sounds in the film. The simulated tactual effects will include at least one of the following devices: 1) device that simulates wind-blowing, 2) device that simulates raining, 3) device that simulates sneezing, and 4) device that simulate shaking and bumping.

In terms of simulation of olfactory effects, at least two odors in the following categories will be included: flower fragrance, perfume scent, coffee smell, cooking odor, fruit smell, sourness, spiciness, funkiness, the smell of raw meat or fish, smoking smell, the smell of gun powder and fresh air.

Odors can be stored either in a liquefied state or in an air-compressed state. When the odor is stored in a liquefied state, it can be evaporated by heating and released through an air pipe before being emitted into the air by way of the odor exits (No air compressor is necessary for the emitting of the odor, which actually can be released by controlling the electromagnetic valve in an odor tank); or odors can be released using pressurized spraying technique and then are emitted into the air through odor exits (In this case, air compressor is necessary for the releasing of odors in the form of fogs).

When odors are stored in an air-compressed state, they can be released into the air pipe through a valve before being emitted into the air by way of the odor exits (In this case, no air compressor is necessary for the emitting of odors, which actually can be released by controlling the electromagnetic valve in the odor tank).

The strength to which the targeted odor is smelled by audiences can be regulated by controlling the length of time used to keep the odor exits open as well as by controlling the size of the odor exit's apertures. The strengths of wind-blowing and raining can also be regulated by controlling the length of time used to keep the wind-blowing exits and the sprinkler heads open as well as by controlling the size of the apertures of the wind-blowing exits and of the sprinkler heads.

Tactual effects can be generated by triggering tactual simulation devices installed around audiences. Specifically:
1. Wind-blowing can be realized by means of electrical fans or air-blowing devices which blow wind upon audiences;
2. Raining can be produced by sprinkling water over audiences, which then free falls upon audiences;
3. Sneezing can be produced by promptly spraying fogs upon audiences, especially upon their faces;
4. Shaking and bumping can be produced by installing servo electromagnetic vibrators or servo hydraulic vibrators which move the cinema seats back and forth, and up and down.

### Example 2

This is a device that produces olfactory and tactual effects in motion pictures. Functionally speaking, this device is made up of devices that can simulate the effects of wind-blowing, raining, sneezing, shaking, and bumping. The device consists of the following parts:

1. A set of odor tanks and corresponding air pipes; and each odor tank contains different odors;

2. Water pipes, pumps, or tap water;

3. Multi-functional emission boxes, which are installed around the seats in the cinema. Each box contains an odor-emitting device, a wind-blowing simulation device, and a raining simulation device. Specifically:
1) The odor-emitting device consists of a set of control system components, a buffer chamber, and an odor exit. The buffer chamber links to the air pipe through the control system components while open to the audience via odor exit. The air pipe connects to one set of odor tanks through another set of control system components, forming the odor-emitting device.
2) The wind-blowing simulation device consists of a fan or a wind-blowing exit and of a set of control system components. The wind-blowing exit and the set of control system components connect to an air compressor or the fan via air pipes.
3) The raining simulation device consists of sprinkler heads and a set of control system components. The sprinkler heads and the set of control system components connect to the water pump and tap water via water pipes.
4) The sneezing-simulation device consists of a fog-spraying head, and its corresponding control system components. The fog-spraying head and the control system components connect to the water pump or the tap water through water pipe;

4. A servo electromagnetic vibrator, a servo hydraulic vibrator and their corresponding control system components. The servo electromagnetic vibrator and the servo hydraulic vibrator are installed on the underside of the seat to produce the effects of shaking and bumping;

5. Control device and drive circuit. The control device is a control circuit or a control module with a CPU processor. The input terminal of the control circuit or the control module receives the olfactory and tactual signals generated in synch with the development of the film plots. The output terminal connects to the control terminal of the drive circuit of each control system component. Each drive circuit connects to its corresponding control system components.

Diagram 2 is the layout schematic drawing that illustrates where devices for odor-producing, wind-blowing-simulating, raining-simulating, and sneezing-simulating are installed in the cinema. Specifically, 1 represents air compressor; 2 represents a set of odor tanks; 5 represents fresh air tank; 6 to 9 represent electromagnetic valve; 10 to 11 represent air pipes; 12 represents partition walls in the cinema; 13 to 21 represent multi-functional emission boxes; 22 to 30 represent pressure relief valve; 31 to 39 represent electromagnetic valves; 40 to 48 represent electromagnetic valves; and 49 to 51 represent water pipes.

Respectively, Diagrams 3 and 4 are the front view and vertical view of the multi-functional emission boxes represented by Diagram 13. The multi-functional emission box is an integral release and simulation device that incorporates odor-emitting, wind-blowing simulation, raining simulation, and sneezing simulation. Generally, each seat in a cinema has one multi-functional emission box installed. In Example 2 the multi-functional emission box is installed on the back of each seat with audiences sitting behind as the target of emission. Diagrams 3 and 4 show that the multi-functional emission box is a flat-shaped box with an odor exit (61) on the top-left side and a sprinkler head (59) and a fog-spraying head (60) on the top-right side. The sprinkler head (59) is used for the simulation of raining, and the fog-spraying head for the simulation of sneezing. On the bottom-left sides are the pressure relief valve (22) and an air pipe (11). Two electromagnetic valves (31 and 40) and one water pipe are located on the bottom-right side.

Diagram 5 is the B-B sectional drawing of Diagram 4 and represents the internal structure of the multi-functional emission box (13). Diagram 5 shows that buffer chamber (62) connects the odor exit (61) and the air pipe (11) on each side, with the sidewall of its chamber decorated with deadening felt (78) and its inside filled with sound-absorbing materials (70). Thanks to the deadening measures taken, the noise coming from the odor tank will be reduced to its minimal level.

In this example, each multi-functional emission box can contain as many as 24 or 36 or even more odor tanks, as is shown in Diagram 2, in which only odor tanks (2-5) are marked. Each odor tank contains different odors, and one of the odor tanks (5) in the diagram contains fresh air.

During film projection, the multi-channel device in the digital film projector detects the olfactory signals and sends them to the control device, which in turn transmits the signals to trigger one of the electromagnetic valves (6-9). After the air compressor forces the odor coming from the corresponding odor tank out into the air pipes (10 and 11), the odor will travel into the multi-functional emission boxes (13-21) by way of pressure relief valves (22-30). Audiences will smell odors in synch with the development of film plots as soon as they are discharged into the air through the buffer chamber (62) and odor exit (61). Those odors may include flower fragrance, perfume scent, coffee smell, cooking odor, fruit smell, smell of sourness, spiciness, funkiness, the smell of raw meat or fish, smoking smell, and the smell of gun powder, Odor tanks can be identified by labeling them so that different odor tanks are arranged in the order of their labels. For example, odor tank 1 is labeled Type A perfume, odor tank 2 Type B perfume, odor tank 3 jasmine fragrance, odor tank 4 coffee smell, and so on.

Electromagnetic valves 31 to 39 function differently from electromagnetic valves 40 to 48 because they are used for different sprinkler heads. Specifically, electromagnetic valves 31 to 39 control the sprinkler heads that simulate raining (e.g. Sprinkler head 59) while electromagnetic valves 40 to 48 control fog-spraying heads that simulate sneezing (e.g. fog-spraying head 60). Details of simulating raining and sneezing are as follows:

During film projection, tactual signals are detected by the multi-channel device in the digital film projector and are released to the control device, which in turn transmits raining-simulating signals or sneezing-simulating signals to trigger one set of electromagnetic valves (31-39) or one set of electromagnetic valves (40-48).

Then water will pass through the corresponding electromagnetic valves into the corresponding sprinkler heads or fog-spraying heads, producing the effects of raining or sneezing in accordance with the film plots.

The effect of raining is generated by spraying water upon above the audience and letting the water free fall. The effect of sneezing is realized by spraying fog directly and briefly onto the faces of the audiences. Sprinkler heads or fog-spraying heads differ from each other in terms of the diameters of the water holes or in terms of the ways water is sprayed in order to adapt to different plots of the film. The sprinkler heads or the fog-spraying heads are all replaceable.

During the process of simulating the effects of odor releasing, raining, and sneezing, the strengths of odor and water-spraying can be regulated by controlling the size of the apertures of the pressure relief valves (22-30), the electromagnetic valves (31-39), and the electromagnetic valves (40-48),

The process of simulating wind-blowing is described as follows: The multi-channel device in the digital film projector detects the tactual signal that simulates the effect of wind-blowing in synch with the plot development of the film and releases the signal to the control device, which then processes and releases the wind-blowing simulation signal. Specifically, in one case, the wind-blowing simulation signal coming from the control device will actuate the fan, which blows wind onto the audiences. In the second case, the wind-blowing simulation signal will trigger the control system components (such as the electromagnetic valve) in the wind exit while the air compressor or fan will also be actuated simultaneously. In the third case, the wind-blowing simulation signal will simultaneously actuate the air compressor, the odor tank that contains fresh air, and the control system components (such as the electromagnetic valve) in the odor exit, producing a simulation of natural wind.

Diagram 6 is the layout schematic drawing of this invention and illustrates the simulation of the effects of shaking and bumping. Diagrams 79-87 indicate audience seats in the cinema; Diagrams 88-96 are servo vibrators; and Diagram 97 specifies the signals that simulate shaking and bumping. The device that simulates shaking and bumping consists of the servo vibrator and the control system components. Being either the servo electromagnetic vibrator or the servo hydraulic vibrator, the servo vibrator is installed on the underside of audience seats and produces the effects of shaking and bumping by moving the seats back and forth, and up and down.

After the multi-channel device in the digital film projector detects the tactual signal and sends the signal to the control device, the control device will release the signal to the control system components (such as switches or relay devices) which activate the servo electromagnetic vibrator or the servo hydraulic vibrator. Then the audience seats are moved back and forth, and up and down. The shaking and bumping effects can be used to simulate the vibration of cars and ships, the zero gravity of airplanes or spaceships, free fall of humans from high cliffs, the effect of earthquakes, and other vibrating activities.

The following examples are used to demonstrate how olfactory signals and tactual signals are generated:

Suppose that the on-off program of the air compressor is set by Group A digits, the types of odor in olfactory signals by Group B digits, the strength of odor by Group C digits, and tactual signals by Group D digits. These programs are set as follows:

The settings of on-off program for the air compressor
0000 0000 off for the air compressor
0000 0001 on for the air compressor

B. The settings of the on-off program for the electromagnetic valve of the odor tank
0000 0000 off for the electromagnetic valve of the odor tank
No.0 0001 0001 on for the electromagnetic valve of the odor tank for fresh air
No. 1 0000 0001 on for the electromagnetic valve of the odor tank for Type A perfume
No. 2 0000 0010 on for the electromagnetic valve of the odor tank for Type B Perfume
No. 3 0000 0011 on for the electromagnetic valve of the odor tank for jasmine Fragrance
No. 4 0000 0100 on for the electromagnetic valve of the odor tank for coffee smell

The settings of program for the electromagnetic valve controlling the strength of odor
0000 0000 “no” odor (The aperture of the electromagnetic valve is “0”)
0000 0001 “weak” odor (The aperture of the electromagnetic valve is small)
0000 0010 “slightly strong” odor (The aperture of the electromagnetic valve is slightly big)
0000 0011 “strong” odor (The aperture of the electromagnetic valve is big)
0000 0100 “very strong” odor (The aperture of the electromagnetic valve is very big)

The settings of on-off program for the tactual signals controlling the electromagnetic valve for water-spraying
0000 0000 off for the electromagnetic valve controlling water flow
0000 0001 on for the electromagnetic valve controlling simulation of sneezing
0000 0010 on for the electromagnetic valve controlling simulation of raining

For example, 20 minutes after a digital film begins, the screen displays Jasmine flowers for three minutes. In this case, the digital film projector should release olfactory signal on the 20^{th} minute to activate the electromagnetic valve in odor tank 3, which emits jasmine fragrance for three minutes.

30 minutes after the digital film begins, there appears a scene in which people are drinking coffee for 5 minutes. In this case, the digital film projector should release the olfactory signal on the 30^{th} minute to activate the electromagnetic valve in odor tank 4, which emits coffee smell for five minutes. The coffee smell coming from the odor tank will be sent by the air compressor to the pressure relief valve before it travels into the multi-functional emission boxes, where it is emitted into the air in the cinema.

Whenever the odor emission period is over, digital film will release olfactory signal to activate the electromagnetic valve of the fresh air tank 0 to refresh the air for one minute. The setting of the olfactory signal for activating the electromagnetic valve of the fresh air tank 0 is “strong.” The air return entrance in the cinema should be in working order all the time.

Suppose that 56 minutes after the digit film begins, a 0.1-minute sneezing appears in the screen. The whole program settings for producing the effects of the above jasmine fragrance, coffee smell, and sneezing are as follows:
T1=0 (minute)
A0000 0000 off for the air compressor
B0000 0000 off for the electromagnetic valve of the odor tank
C0000 0000 “no” odor
D0000 0000 off for the electromagnetic valve of the tap water
T12=20 (minutes)
A0000 0001 on for the air compressor
B0000 0011 on for the electromagnetic valve of the jasmine odor tank (No.3)
C0000 0001 “weak” odor
D0000 0000 off for the electromagnetic valve of the tap water
T13=23 (minutes)
A0000 0001 on for the air compressor
B0000 0000 off for the electromagnetic valve of the odor tank
0000 0001 on for the electromagnetic valve of the fresh air tank
C0000 0011 “strong” odor
D0000 0000 off for the electromagnetic valve of the tap water
T14=24 (minutes)
A0000 0000 off for the air compressor
B0000 0000 off for the electromagnetic valve of the odor tank
C0000 0000 “no” odor
D0000 0000 off for the electromagnetic valve of the tap water
T15=30 (minutes)
A0000 0001 on for the air compressor
B0000 0100 on for the electromagnetic valve of the coffee smell tank (No.4)
C0000 0011 “strong” odor (The aperture of the electromagnetic valve is big)
D0000 0000 off for the electromagnetic valve of the tap water
T16=35 (minutes)
A0000 0001 on for the air compressor
B0000 0000 off for the electromagnetic valve of the odor tank
0001 0001 on for the for the electromagnetic valve of the fresh air tank (No.0)
C0000 0011 “strong” odor (The aperture of the electromagnetic valve is big)
D0000 0000 off for the electromagnetic valve of the tap water
T17=36 (minutes)
A0000 0000 off for the air compressor
B0000 0000 off for the electromagnetic valve of the odor tank
C0000 0000 “no” odor
D0000 0000 off for the electromagnetic valve of the tap water
T18=56 (minutes)
A0000 0000 off for the air compressor
B0000 0000 off for the electromagnetic valve of the odor tank
C0000 0000 “no” odor
D0000 0001 on for the electromagnetic valve of the sneezing effect
T19=56.1 (minutes)
A0000 0000 off for the air compressor
B0000 0000 off for the electromagnetic valve of the odor tank
C0000 0000 “no” odor
D0000 0000 off for the electromagnetic valve of the tap water

If there is no need to program the olfactory signals as “week” or “strong,” common electromagnetic valves can be used in this invention. If the division of odors into “weak” or “strong” is necessary, special electromagnetic valves such as servo electromagnetic valve should be the choice.

Installed outside the cinema together with the air compressor and attached directly to the electromagnetic valves, odor tanks are connected to the odor exits installed inside the cinema by means of air pipes. In addition, odor tanks are connected to pressure relief valves and multi-functional emission boxes that are installed in different locations inside the cinema. The air inside the cinema can be refreshed by the central air conditioner system. Or new fresh air entrance and return system may be installed. Air compressor should be capable of producing air pressure strong enough to force odors out. Water used for spraying can come from tap water or from the water pump.

The above examples have been used to illustrate the technical concepts and features of this invention so that those who are experts in such technology are able to comprehend the contents of the invention and have it applied in relevant fields. This does not exclude this invention from being protected by patent protection laws. Any forms of modifications or alterations equivalent to and/or based on the fundamentals of this invention are included as part of this invention under patent protection laws. For example, the retardation time for the release of odors is not included in the above examples.

1. It is a kind of method relating to generate olfactory and tactual effects in motion pictures. It is characteristic of the following:
1) Based on the development of film plots, olfactory and tactual signals that work in concert with visual and auditory signals in the film will be generated and the default signal system for the olfactory and tactual signals will be one of these: digital, analog, optical, or magnetic. Olfactory signals will be released according to the types of the targeted odors, and tactual signals will include at least one of the following signals:
A. Signal that simulates wind-blowing;
B. Signal that simulates raining;
C. Signal that simulates sneezing;
D. Signal that simulates shaking;
E. Signal that simulates bumping
2) One of the two following modes will be chosen for the production of olfactory and tactual signals:
A. Olfactory and tactual signals are integrated in combination with the visual and auditory signals of the film;
B. Olfactory and tactual signals are generated using simulation programming independent of but in synchronization with the visual and auditory signals of the film.
3) During the process of film projection, olfactory and tactual signals are released in synchronization with the development of the plots of the film. Specifically, after being detected by a detection circuit, olfactory signals activate a set of control units by means of a control circuit. The set of control units then forces odors into their corresponding pipes while activating the odor exits located around audiences where odors that correspond to the pictures and sounds in the film are sent off.
Similarly, upon being detected by the detection circuit, tactual signals activate a set of control units and trigger the corresponding tactual simulation devices located around audiences, producing simulated tactual effects that synchronize with the corresponding pictures and sounds in the film. The devices that produce simulated tactual effects will include at least one of the following:
A. Device that simulates wind-blowing;
B. Device that simulates raining;
C. Device that simulates sneezing;
D. Device that simulate shaking and/or bumping.

2. Based on what was stated in Part 1 in terms of the invention that deals with the generation of olfactory and tactual signals, different odors that are generated by the olfactory signals should include at least two different types of odors in the following categories: Flower fragrance, perfume scent, coffee smell, cooking odor, fruit smell, the smell of sourness, spiciness, funkiness, the smell of raw meat or fish, smoking smell, the smell of gun powder, and fresh air.

3. Based on what was stated in Part 1 in terms of the invention that deals with the generation of olfactory and tactual signals, odors can be stored either in a liquefied state or in an air-compressed state. When the odor is stored in a liquefied state, it can be evaporated by heating and released through an air pipe before being emitted into the air by way of the odor exits; or odors can be released using pressurized spraying technique and then are emitted into the air through odor exits. When odors are stored in an air-compressed state, they can be released into the air pipe through a valve before being emitted into the air by way of the odor exits.

4. Based on what was stated in Part 1 in terms of the invention that deals with the generation of olfactory and tactual signals, the strength to which the targeted odor is smelled by audiences can be regulated by controlling the length of time used to keep the odor exits open as well as by controlling the size of the odor exits' apertures. The strengths of wind-blowing and raining can also be regulated by controlling the length of time used to keep the wind-blowing exits open and the sprinkler heads open as well as by controlling the size of the apertures of the wind-blowing exits and of the sprinkler heads.

5. Based on what was stated in Part 1 in terms of the invention that deals with the generation of olfactory and tactual signals, tactual effects can be generated by triggering tactual simulation devices installed around audiences. Specifically:
1) Wind-blowing can be produced by means of electrical fans or air-blowing devices which blow wind upon audiences;
2) Raining can be produced by sprinkling water over audiences, which then free falls upon audiences;
3) Sneezing can be produced by promptly spraying fogs upon audiences, especially upon their faces;
4) Shaking and bumping can be produced by installing servo electromagnetic vibrators or servo hydraulic vibrators which move the cinema seats back and forth, and up and down.

6. This olfactory- and tactual-generating device consists of olfactory-simulation device and tactual-simulation device, which include the following:
1) A set of odor tanks and corresponding air pipes; and each odor tank contains different odors;
2) Water pipes, pumps, or tap water;
3) Multi-functional emission boxes, which are installed around the seats in the cinema. Each emission box contains an odor-emitting device, a wind-blowing simulation device, and a raining simulation device.
Specifically, the odor-emitting device consists of a set of control system components, a buffer chamber, and an odor exit. The buffer chamber links to the air pipe through the control system components while open to the audience via odor exit. The air pipe connects to one set of odor tanks through another set of control system components, forming the odor-emitting device. The wind-blowing simulation device consists of a fan or a wind-blowing exit and of a set of control system components. The wind-blowing exit and the set of control system components connect to an air compressor or the fan via air pipes.
The raining simulation device consists of sprinkler heads and a set of control system components. The sprinkler heads and the set of control system components connect to the water pump and tap water via water pipes; Control device and drive circuit. The control device is a control circuit or a control module with a CPU processor. The input terminal of the control circuit or the control module receives the olfactory and tactual signals generated in synch with the development of the film plots. The output terminal connects to the control terminal of the drive circuit of each control system component. Each drive circuit connects to its corresponding control system components.

7. Based on what was stated in Part 6 in terms of the devices that produce Olfactory and tactual effects, the multi-functional emission boxes are installed on one of the following positions:
1) The hind back of each seat in the cinema with the audience sitting behind as the emission target;
2) The underside of each seat with the audience sitting above as the emission target;
3) The front of each seatback with the audience sitting in the same seat as the emission target.

8. Based on what was stated in Part 6 in terms of the devices that produce olfactory and tactual effects, the buffer chamber in the technical scenario is a chamber whose sidewall is decorated with deadening felt and whose inside is filled with sound-absorbing materials.

9. Based on what was stated in Part 6 in terms of the devices that produce olfactory and tactual effects, the multi-functional emission box also contains a sneezing-simulation device, which consists of a fog-spraying head, and its corresponding control system components. The fog-spraying head and the control system components connect to the water pump or the tap water through water pipe.

10. Based on what was stated in Part 6 in terms of the devices that produce olfactory and tactual effects, the olfactory and tactual simulation devices include a servo electromagnetic vibrator, a servo hydraulic vibrator, and corresponding control system components. The servo electromagnetic vibrator and the servo hydraulic vibrator are installed on the underside of the seat to produce the effects of shaking and bumping.
